(19) United States
(12) Patent Application Publication
(10) Pub. No.: US 2008/0244472 A1
(43) Pub. Date: Oct. 2, 2008

(54) METHOD FOR ACCELERATING THE GENERATION OF AN OPTIMIZED GATE-LEVEL REPRESENTATION FROM A RTL REPRESENTATION

(75) Inventors: Anshuman NAYAK, Noida (IN); Samantak CHAKRABARTI, Noida (IN); Satrajit PAL, Noida (IN); Hitanshu DEWAN, Rohini (IN)

Correspondence Address: SUGHRUE MION, PLLC, 2100 Pennsylvania Avenue, N.W., Washington, DC, 20037, US

(73) Assignee: ATRENTA, INC., San Jose, CA (US)

(21) Appl. No.: 11/692,949

(22) Filed: Mar. 29, 2007

(51) Int. Cl. G06F 17/50

(52) U.S. Cl. 716/2

(57) ABSTRACT

A method for accelerating the generation of an optimized netlist from a RTL representation is provided. The method optimizes a given RTL description of an integrated circuit (IC) design by: generating a static single assignment (SSA) graph; creating value range propagation for each variable in the SSA graph; and, applying one or more of a set of optimization algorithms on the SSA graph. The optimization algorithms include, but are not limited to, dead-code elimination, bitwidth analysis, redundancy elimination, iteration loop optimization, algebraic simplification and so on. These algorithms operate on a word-level description to enable fast optimization. Furthermore, the optimized RTL accelerates the overall flow of an IC design.

### FIELD OF THE INVENTION

The present invention relates generally to integrated circuit (IC) design automation tools, and more particularly to design automation tools for analyzing and optimizing IC designs.

### BACKGROUND OF THE INVENTION

State of the art electronic design automation (EDA) systems for designing complex integrated circuits (ICs) involve the use of several software tools for the creation and verification of designs of such circuits. The design of most digital ICs is a highly structured process based on a hardware description language (HDL) methodology. The HDL code provides a level of design abstraction referred to as the register transfer level (RTL), and is typically implemented using a HDL language, such as Verilog or VHDL. At the RTL level of abstraction, the IC design is specified by describing the operations that are performed on data as it flows between circuit inputs, outputs, and clocked registers.

The IC design, as expressed by the RTL code, is synthesized to generate a gate-level description, or a netlist. Synthesis is a step taken to translate the architectural and functional descriptions of the design, represented by RTL code, to a lower level of representation of the design such as logic-level and gate-level descriptions. The IC design specification and the RTL code are technology independent. That is, the specification and the RTL code do not specify the exact gates or logic devices to be used to implement the design. However, the gate-level description of the IC design is technology dependent.

Typically, a designer tries to optimize the netlist results (e.g., timing, area, power consumption) within the synthesis tools, guided by applying one or more optimization strategies on the result netlist. However, even when sophisticated strategies are used for optimization, the quality of the resultant netlist depends heavily on the RTL code. Inefficient RTL coded functions increase logic optimization time, and may still result in a less than optimal code or circuits. In addition, inefficient RTL code may increase design to silicon turnaround time as both layout analysis and static timing analysis would require additional time. Thus, optimizing a synthesized netlist is an inefficient and very time consuming approach.

Techniques for RTL code optimization may be found in U.S. Pat. Nos. 7,086,015 and 6,438,730 incorporated herein in their entirety by reference for the useful understanding of the background of the invention. Although these techniques operate on the RTL code, they are designed to optimize only a certain portion of the design. For example, the '015 patent provides a method for optimizing complex structure (e.g., a device connected to a total number of signal lines that exceeds a user defined threshold of the number of signal lines of an optimum multiplex structure) and the '730 patent discloses a method for optimizing decision constructs (e.g., case, if-else, if-else-if, etc.). Consequently, the design must be optimized, at least once more, after netlist generation.

Therefore, it would be advantageous to provide a solution for accelerating the generation of a netlist by generating an optimized RTL representation for the entire design.

### SUMMARY OF THE INVENTION

The invention involves, in one aspect, a method for accelerating the generation of an optimized netlist from a RTL representation. According to this aspect, a given RTL description of an integrated circuit (IC) design is optimized by: generating a static single assignment (SSA) graph; creating value range propagation for each variable in the SSA graph; and applying a set of optimization algorithms on the SSA graph. The optimization algorithms include, but are not limited to, dead-code elimination, bitwidth analysis, redundancy elimination, iteration loop optimization, algebraic simplification and so on. These algorithms operate on a word-level description to enable fast optimization. Furthermore, the optimized RTL accelerates the overall flow of an IC design.

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 is a flowchart describing the method for optimizing a RTL description of an IC design in accordance with an embodiment of the present invention.

FIGS. 2A and 2B are exemplary CDFG and SSA graphs.

FIG. 3 is a flowchart describing the method for performing value-based code optimization in accordance with an embodiment of the present invention.

FIG. 4 is a flowchart describing the method for performing redundancy elimination optimization in accordance with an embodiment of the present invention.

FIG. 5 is a non-limiting list of rules and simplified expressions utilized for the optimization of algebraic and Boolean expressions in accordance with an embodiment of the present invention

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

To overcome the drawbacks of prior art synthesis and RTL design tools the present invention provides a method for accelerating the generation of an optimized netlist from a RTL representation. The method optimizes a given RTL description of an integrated circuit (IC) design by: generating a static single assignment (SSA) graph; creating value range propagation for each variable in the SSA graph; and, applying a set of optimization algorithms on the SSA graph. The optimization algorithms include, but are not limited to, dead-code elimination, bitwidth analysis, redundancy elimination, iteration loop optimization, algebraic simplification and so on. These algorithms operate on a word-level description to enable fast optimization.

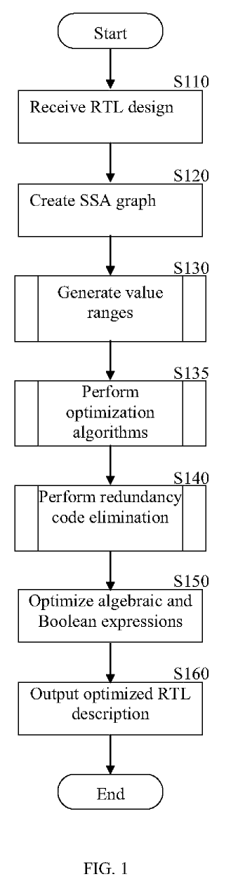

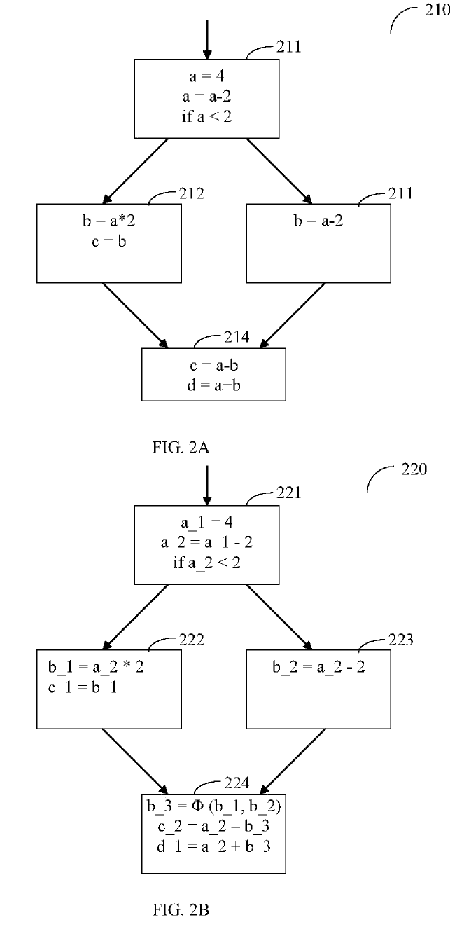

FIG. 1 shows a non-limiting and exemplary flowchart 100 describing the method for optimizing a RTL description of an integrated circuit (IC) design in accordance with an embodiment of the present invention. At S110, a code representing a RTL description of an IC design is received. The code may be written in HDL including, but not limited to, Verilog, VHDL and the like. At S120, each and every usage of a variable in the input code is assigned with a unique definition or assignment by creating a SSA graph. The generation of a SSA graph includes traversing a control data flow graph (CDFG), replacing the left hand side (LHS) of each assignment with a new variable, and inserting Φ functions (phi functions) when multiple definitions of a variable reaching a use of a variable is encountered. For example, FIGS. 2a and 2b show a SSA graph generated for the following RTL description:

```
a = 4;
a = a−2;
if a < 2{
    b = a*2;
    c = b;
} else {
    b = a−2;
}
c = a−b;
d = a+b;
```

A CDFG 210 representing the above code is provided in FIG. 2A. To generate a SSA graph 220, shown in FIG. 2B, a LHS of each assignment in the CDFG 210 is replaced with a new variable. The variable name is uniquely defined using the notation:

<variable name>_unique number

For example, the assignment a=4, is changed to a_{—}1=4. Subsequent uses of the new variables are changed accordingly. The use of variable b in block 224 could be referring to either b_{—}1 or b_{—}2, depending upon where the control flow arrives from. This is considered as multiple definitions of a variable reaching a use of a variable, and thus a Φ function is added to block 224 to resolve the state of multiple definitions. This function generates a new definition of b, b_{—}3, by selecting either b_{—}1 or b_{—}2, depending on the control flow. All RTL optimizations are performed on the generated SSA graph. An advantage of a SSA graph is that each of the different uses of a variable has a unique reaching definition, and thus RTL optimization processes can be carried out in a more simple and accurate manner than was possible in prior attempts.

At S130, a value range engine operates on the SSA graph to generate value ranges by propagation. This operation results in a determination of the minimum and maximum values that each variable in the SSA graph can take. Specifically, the value range engine performs forward and backward traversals on the SSA graph to successively refine the value ranges. The forward traversal ensures that all variables that feed an operation are computed before the operation is encountered. For example, the value range of variable a_{—}2 is determined before reaching the “if” statement in block 221 (see FIG. 2B). The backward traversal ensures that a left hand side (LHS) of an assignment statement constrains a right hand side (RHS) of the assignment. In addition, the value range engine performs constant propagation to detect variables with a constant value. This is used to ensure that all computations which can be performed at compilation time would be performed statically and without generating any hardware for those computations. The value range engine maintains a data structure with the minimum and maximum values of each variable in the SSA graph.

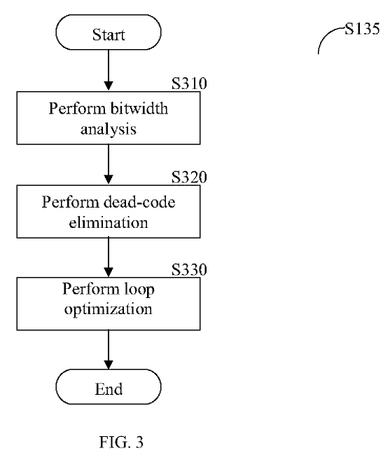

At S135, using the value ranges calculated for the variables, a series of value-based optimization procedures is performed. The optimization procedures preferably include at least one of the following: bitwidth analysis, dead code elimination, as well as loop and branch condition optimizations. FIG. 3 shows the execution of S135 in greater detail.

At S310, a bitwidth analysis is performed to discover the smallest variable type for each static variable assignment in the RTL code while retaining code correctness. The bitwidth analysis is further utilized to instantiate operators of the appropriate bitwidth, thereby reducing the total number of gates in the final netlist. For example, for the following RTL description only a 4-bit adder is instantiated and not an 8-bit adder as would have been proposed by prior art synthesis tools.

reg[7:0]a,b,c;

reg[3:0]x,y;

a=x;

b=y;

c=a+b;

At S320 a procedure for dead-code elimination is performed. A computation is ‘dead’ if it computes only values that do not affect the final output. The detection of dead code is achieved by traversing the SSA graph and using the value range propagation data. At S330, loop optimization is performed for the purpose of replacing expensive (in terms of number of gates and execution time) operations, such as multiplications and divisions, by less expensive operations, such as additions and subtractions. For example, in the following RTL description:

for i = 1 to i =100
a(i) = 202 − 2*i;
end for

the “for loop” is changed in such way that it does not include any multiplications. That is, the optimized code is as follows:

```
t1 = 202
for i = 1 to i = 100
    t1 = t1−2;
    a(i) = t1;
end for
```

Referring back to FIG. 1, at S140 a redundancy code elimination process is carried out. This process operates on the SSA graph, generated at S120, and does not require any input from the value range engine. The redundancy code elimination executes various optimization procedures, such as value numbering, common sub expression (CES) elimination, loop invariant code motion, and code hoisting to achieve optimized control and data paths.

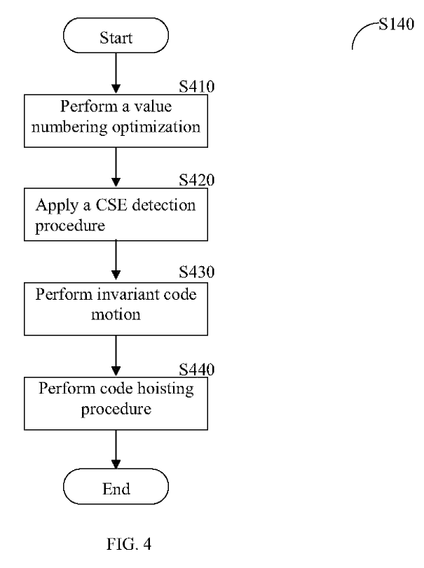

FIG. 4 shows the execution of S140 in greater detail. At S410 a value numbering procedure is carried out to determine whether two or more computations are equivalent. If equivalent computations are found, the redundant statements are eliminated. This is achieved by associating a symbolic value with each computation without interpreting the operation performed. Any two computations with the same symbolic value always compute the same value. For example, in the following RTL description the variables j and l are assigned to the same value:

j=i+1;

k=i;

j=k+1;

At S420 a common sub expression (CSE) detection procedure is preformed. Specifically, the CSE procedure operates on the SSA graph, which has only one assignment for each variable. The CSE procedure looks for computations that are always performed at least twice on a given execution path. All redundant computations (i.e., the later occurrences of an expression) are eliminated from the code. As an example, in the following RTL description:

```
m = 2*i
if(i > 0) {
    j = 2 * i;
} else {
    k = 2 * i;
}
```

The expression “2*i” is a CSE which is removed from the code. The optimized RTL description is as follows:

```
m = 2*i
f(i > 0) {
    j = m;
} else {
    k = m;
}
```

At S430 a procedure for loop invariant code motion is performed. By traversing the SSA graph the procedure recognizes computations in loops that produce the same value in every iteration. Such computations are placed out of the loop. For example, in the following RTL description:

```
for i = 1 to 1=100
    l = i * (n+2);
    for j = i to j = 100
        a(i,j) = 100*n + 10*l +j;
```

The computation “n*100” produces the same value in every iteration, and therefore is moved out from the “for” loops. The optimized RTL description is as follows:

```
t = 100*n;
for i = 1 to 1=100
    l = i * (n+2);
    for j = i to j = 100
        a(i,j) = t + 10*l +j;
```

At S440 a procedure for code hoisting is performed. This procedure detects expressions, which are always evaluated following some point in a program, regardless of the execution path. Such expressions are moved to the latest point beyond which they would always be evaluated. The code hoisting reduces the total number of gates in the output generated netlist.

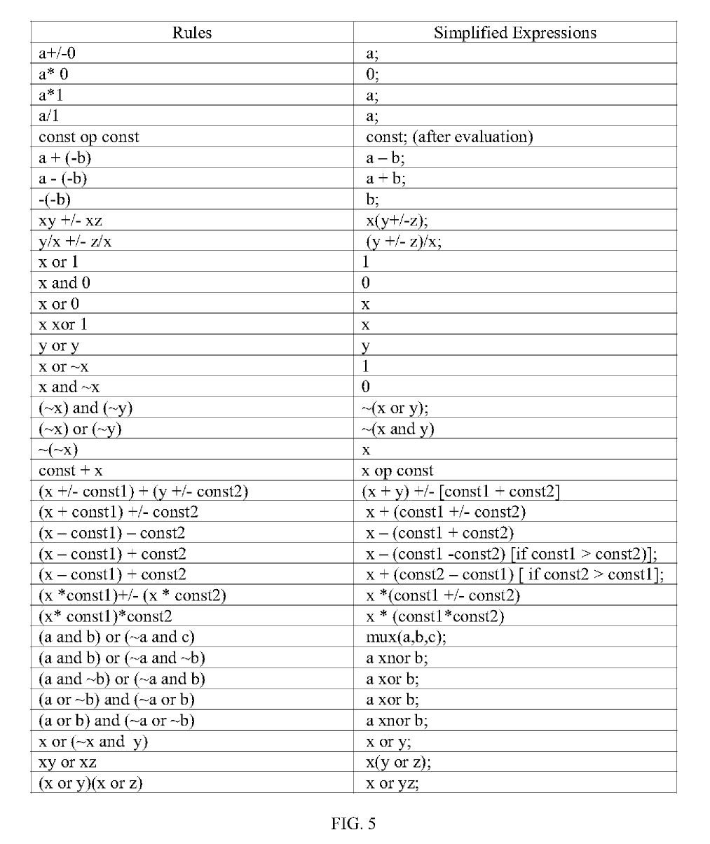

Referring back to FIG. 1, at S150 optimization of algebraic and Boolean expressions in the RTL code is performed. With this aim, the SSA graph is traversed and a set of predefined rules is applied on each node. If a rule is satisfied, the respective expression (i.e., node) is replaced with a simplified expression. The rules are used both for algebraic and Boolean optimization. For example, an algebraic rule may be “a/1” and, when matched, such an expression may be replaced with the simplified expression “a”. A non-limiting list of rules and simplified expressions is provided in FIG. 5. In accordance with another embodiment of the present invention Boolean expression can be optimized using a Shannon expansion theorem. At S160, the optimized SSA graph (i.e., the optimized RTL) is forwarded to a synthesis tool to generate an optimized gate level netlist. It will be apparent to a person skilled in the art that, since the input SSA graph represents an optimized RTL description, the time required for a synthesis tool to generate an optimized netlist is significantly less than the time required for generating a netlist from an un-optimized RTL description. It should be noted the generated RTL description can be further optimized by a standard Boolean optimization technique. The time required for optimization, however, is significantly less than the time required if processing un-optimized RTL.

Many variations to the above-identified embodiments are possible without departing from the scope and spirit of the invention. Possible variations have been presented throughout the foregoing discussion. Moreover, it will be appreciated that there are many instances in which the steps shown can be performed in an order different from the particular implementation shown. In addition, not every step shown needs to be performed, and substitutions may occur to those familiar with this field.

Combinations and subcombinations of the various embodiments described above will occur to those familiar with this field, without departing from the scope and spirit of the invention.

Finally, it will be appreciated that various useful reports and outputs will occur to those familiar with this field. For example, a report showing optimizations made can be generated from each of the optimizations performed in step S135. A redundant code elimination can be generated following step S140. An expression replacement report can be generated following step S150. Reports can be generated after each sub-step in FIG. 4, such as a CSE detection report, an invariant code motion report, a code hoisting report, and the like.

As a useful output, the optimized RTL description may be stored in a temporary or permanent memory for the sake of follow-on processing.

Those familiar with this field will understand that, although the simplified examples are easy to understand, they are presented in such a manner solely for the sake of teaching the concepts of the invention, and that the application to a real situation, of the steps described above, must be performed in the main with a computer system that includes a processor and a memory under control of the processor.

There is claimed:

1. A computer implemented method for optimizing a register transfer level (RTL) description of an integrated circuit (IC) design, comprising:
assigning a unique definition for each variable in the RTL description;
for each variable having the unique definition, generating value range propagation;
performing one or more value-based optimization procedures on the RTL description, taking into account the value range propagation;
eliminating redundancy code in the RTL description;
optimizing algebraic and Boolean expressions in the RTL description; and
storing the resulting optimized RTL description in a memory.

2. The method of claim 1, wherein the RTL description includes a hardware description language (HDL) code.

3. The method of claim 1, wherein assigning the unique definition to each variable comprises generating a static single assignment (SSA) graph.

4. The method of claim 3, wherein generating the SSA graph comprises:
traversing a control data flow graph (CDFG);
replacing a variable of a left hand side (LHS) of each assignment in the RTL description with a new variable name; and
inserting a phi function, when encountering multiple definitions of a variable, reaching a use of a variable.

5. The method of claim 4, wherein the value range propagation detects the minimum and maximum values for each variable.

6. The method of claim 5, wherein generating the value range propagation comprises;
forward traversing the SSA graph to compute the value range propagation for the variable before an operation using the variable is encountered;
backward traversing the SSA graph to determine whether a variable of a LHS of an assignment constrains a right hand side (RHS) of the assignment; and
performing constant propagation to determine whether the variable has a constant value.

7. The method of claim 1, wherein the value-based optimization procedures comprise one or more of: bitwidth analysis, dead-code elimination, and loop structure optimization.

8. The method of claim 1, wherein eliminating the redundancy code comprises performing one or more of: value numbering to eliminate redundant computations, detection of common sub expressions (CSE), loop invariant code motion, and code hoisting.

9. The method of claim 3, wherein optimizing the algebraic and Boolean expressions comprises:
traversing the SSA graph;
applying a set of predefined rules on each expression in the SSA graph; and
replacing the expression with a respective simplified expression when one of the rules is satisfied.

10. The method of claim 9, wherein optimizing the Boolean expressions further comprises performing Shannon expansion optimization.

11. The method of claim 1, further comprising generating an optimized netlist, from the optimized RTL description, with a synthesis tool.

12. The method of claim 1, implemented in one of a computer aided design (CAD) system and a CAD program.

13. A computer program product for enabling a computer system to perform operations for an integrated circuit (IC) design method, intended for optimizing a register transfer level (RTL) description of the IC design, the computer program product having computer instructions on a computer readable medium, the operations comprising:
assigning a unique definition for each variable in the RTL description;
for each variable having the unique definition, generating value range propagation;
performing one or more value-based optimization procedures on the RTL description, taking into account the value range propagation;
eliminating redundancy code in the RTL description; and
optimizing algebraic and Boolean expressions in the RTL description.

14. The computer program product of claim 13, wherein the RTL description includes a hardware description language (HDL) code.

15. The computer program product of claim 13, wherein assigning the unique definition to each variable comprises generating a static single assignment (SSA) graph.

16. The computer program product of claim 15, wherein generating the SSA graph comprises:
traversing a control data flow graph (CDFG);
replacing a variable of a left hand side (LHS) of each assignment in the RTL description with a new variable name; and
inserting a phi function when encountering multiple definitions of a variable, reaching a use of a variable.

17. The computer program product of claim 16, wherein the value range propagation detects the minimum and maximum values for each variable.

18. The computer program product of claim 17, wherein generating the value range propagation comprises;
forward traversing the SSA graph to compute the value range propagation for the variable before an operation using the variable is encountered;
backward traversing the SSA graph to determine whether a variable of a LHS of an assignment constrains a right hand side (RHS) of the assignment; and
performing constant propagation to determine whether the variable has a constant value.

19. The computer program product of claim 18, wherein the value-based optimization procedures comprise one or more of bitwidth analysis, dead-code elimination, and loop structure optimization.

20. The computer program product of claim 13, wherein eliminating the redundancy code comprises performing any of value numbering to eliminate redundant computations, detection of common sub expressions (CSE), loop invariant code motion, and code hoisting.

21. The computer program product of claim 15, wherein optimizing the algebraic and Boolean expressions comprises:
traversing the SSA graph;
applying a set of predefined rules on each expression in the SSA graph; and
replacing the expression with a respective simplified expression when one of the rules is satisfied.

22. The computer program product of claim 21, wherein optimizing the Boolean expressions further comprises performing Shannon expansion optimization.

23. The computer program product of claim 13, further comprising generating an optimized netlist, from the optimized RTL description, with a synthesis tool.

24. The computer program product of claim 13, implemented in one of a computer aided design (CAD) system and a CAD program.
